(19) United States
(12) Patent Application Publication
(10) Pub. No.: US 2026/0090532 A1
(43) Pub. Date: Apr. 2, 2026

(54) FISHING REEL

(71) Applicant: GLOBERIDE, Inc., Tokyo (JP)

(72) Inventor: Taro IKE, Higashikurume-shi (JP)

(73) Assignee: GLOBERIDE, Inc., Tokyo (JP)

(21) Appl. No.: 19/307,076

(22) Filed: Aug. 22, 2025

(30) Foreign Application Priority Data
Sep. 27, 2024 (JP) 2024-169051

(51) Int. Cl. A01K 89/015

(52) U.S. Cl. CPC A01K 89/0192

(57) ABSTRACT

A fishing reel comprises a reel body comprising: a spool around which a fishing line is wound; a handle configured to perform a winding-up operation on the spool; and a winding-up driving mechanism installed between the spool and the handle and configured to transmit the winding-up operation of the handle to the spool. The reel body comprises a side plate that covers the winding-up driving mechanism, and a washer-type anticorrosion member is screwed to the side plate.

### CROSS-REFERENCE TO RELATED APPLICATION

This application claims priority under 35 U.S.C. § 119 to Japanese Patent Application No. 2024-169051 filed on September 27, 2024 in the Japanese Patent Office, the entire contents of each hereby incorporated by reference.

### BACKGROUND OF THE INVENTION

### 1. TECHNICAL FIELD

The present invention relates to a fishing reel provided with a corrosion member.

### 2. DESCRIPTION OF THE RELATED ART

The fishing reel described above includes a large number of components in order to exhibit predetermined functions, and is used in an environment that is close to moisture such as seawater or water (in a conductive atmosphere). The components have a structure in which the components are organically associated with (in contact with or in the proximity of) each other, and include a variety of materials. Therefore, in a portion where different types of materials having a potential difference are associated with each other, the potential difference is generated, and corrosion (electrolytic corrosion) is accelerated in a use environment in which the component members are exposed to the conductive atmosphere described above as described in JP H11-225633 A.

Therefore, in order to avoid corrosion of components in a reel body, JP 2023-084191 A discloses a technique in which a corrosion member is provided on a set plate to make this portion proactively corroded and avoid the corrosion of the components.

### SUMMARY OF THE INVENTION

Although the corrosion member disclosed in JP 2023-084191 A described above is effective for suppressing the corrosion of the components, there is room for further improvement in the size, thickness, installation location, and installation mode thereof. In particular, in a dual-bearing reel, it is preferable to exhibit an effective anticorrosion effect while preventing an increase in size or thickness in consideration of a use mode depending on a type of the reel, an arrangement density of internal components, and the like.

An object of the present invention is to provide a fishing reel comprising an anticorrosion member that can effectively avoid corrosion of main components and does not increase a size of a reel body.

A fishing reel according to the present invention comprises a reel body comprising a spool around which a fishing line is wound, a handle configured to perform a winding-up operation on the spool, a winding-up driving mechanism installed between the spool and the handle and configured to transmit the winding-up operation of the handle to the spool. The reel body comprises a side plate that covers the winding-up driving mechanism. A washer-type anticorrosion member is screwed to the side plate.

The washer-type anticorrosion member can comprise a material capable of avoiding corrosion of components of the winding-up driving mechanism, the components comprising different types of materials which are different in a raw material, for example, a material having a potential difference that is greater than a potential difference generated between the components of the winding-up driving mechanism, similarly to the configuration disclosed in JP 2023-084191 A described above. Specifically, when a material having a great ionization tendency (for example, zinc, titanium, aluminum, magnesium, or the like) is used, the washer-type anticorrosion member is proactively corroded to avoid the corrosion of the components. The “anticorrosion member” in the present invention is a member that proactively promotes corrosion, and is also referred to as a “corrosion member”.

The material that is included in the anticorrosion member (corrosion member) and has a great ionization tendency can be selected according to the materials included in the components. When such a material having a great ionization tendency is arranged in the periphery of (or may be arranged in contact with) the components of the reel body, even if conductive liquid such as seawater or water enters to generate a flow of electrons, the flow of electrons can be preferentially generated in the anticorrosion member, and an effect of avoiding the corrosion of the components can be obtained.

Furthermore, it has been found that such an anticorrosion member can exhibit a sufficient anticorrosion effect for the components in the vicinity thereof even when the anticorrosion member is configured in a washer type and screwed to the side plate of the reel body. When such a washer-type anticorrosion member is screwed to the side plate of the reel body, the fishing reel having a high anticorrosion effect can be obtained without increasing the size and thickness of the reel body.

Furthermore, the present invention also provides a fishing reel that comprises a reel body comprising a spool around which a fishing line is wound, a handle configured to perform a winding-up operation on the spool, a winding-up driving mechanism installed between the spool and the handle and configured to transmit the winding-up operation of the handle to the spool. The reel body comprises a housing that houses the winding-up driving mechanism. A washer-type anticorrosion member is screwed to an inner face of the housing.

As described above, the present invention can exhibit the anticorrosion effect by screwing the washer-type anticorrosion member to the inner face of the housing (a main body) constituting various types of fishing reels, specifically, a dual-bearing reel, a spinning reel, and a single-bearing reel.

According to the present invention, it is possible to obtain the fishing reel comprising the anticorrosion member that can effectively avoid the corrosion of the main components and does not increase the size of the reel body.

### BRIEF DESCRIPTION OF THE DRAWINGS

FIG. 1 is a plan view illustrating a first embodiment (a dual-bearing reel) of a fishing reel;

FIG. 2 is a rear view of the fishing reel illustrated in FIG. 1;

FIG. 3 is a side view viewed from a side of a handle of the fishing reel illustrated in FIG. 1;

FIG. 4 is a side view viewed from an opposite side from the handle of the fishing reel illustrated in FIG. 1;

FIG. 5 is a view illustrating an internal configuration of the fishing reel illustrated in FIG. 1;

FIG. 6 is a cross-sectional view taken along line A-A of FIG. 3;

FIG. 7 is a view of a right-hand side plate of the fishing reel illustrated in FIG. 1 as viewed from the inside;

FIG. 8 is a view illustrating an example of a configuration of a winding-up driving mechanism of the fishing reel illustrated in FIG. 1 and an arrangement position of a washer-type anticorrosion member;

FIG. 9 is a view illustrating a fixing example in which the washer-type anticorrosion member is screwed to an inner face of a side plate;

FIG. 10A is a view illustrating another fixing example in which the washer-type anticorrosion member is screwed to the inner face of the side plate; FIG. 10B is a view illustrating still another fixing example in which the washer-type anticorrosion member is screwed to the inner face of the side plate;

FIG. 11A is a photograph showing a corrosion state of components when the washer-type anticorrosion member is not mounted on a right-hand side plate, and FIG. 11B is a photograph showing a corrosion state of the components when the washer-type anticorrosion member is mounted on the right-hand side plate;

FIG. 12 is a plan view illustrating a second embodiment of the fishing reel;

FIG. 13 is a side view of the fishing reel illustrated in FIG. 12;

FIG. 14 is a cross-sectional view taken along line B-B of FIG. 13;

FIG. 15 is a view of a side plate of the fishing reel illustrated in FIG. 12 as viewed from the inside; and

FIG. 16 is a view illustrating a configuration of a winding-up driving mechanism of the fishing reel illustrated in FIG. 12 and an arrangement position of a washer-type anticorrosion member.

### DETAILED DESCRIPTION

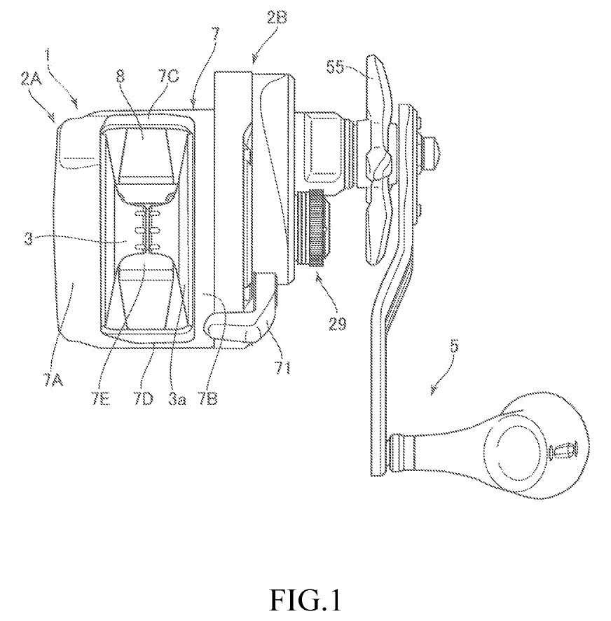

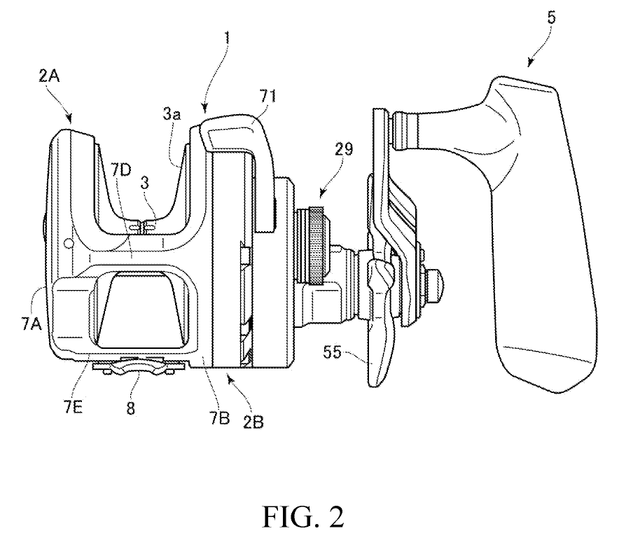

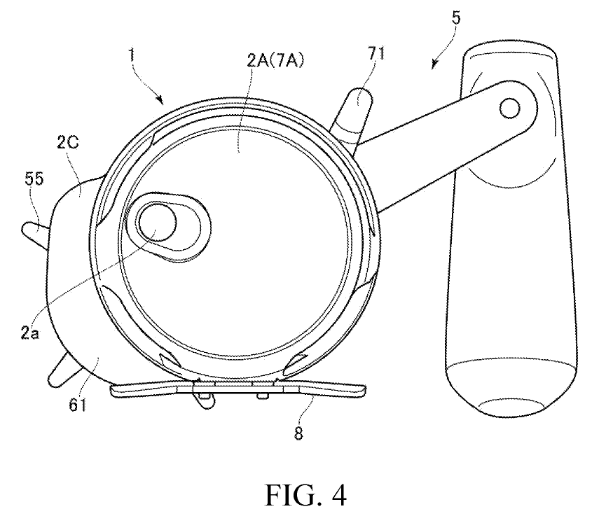

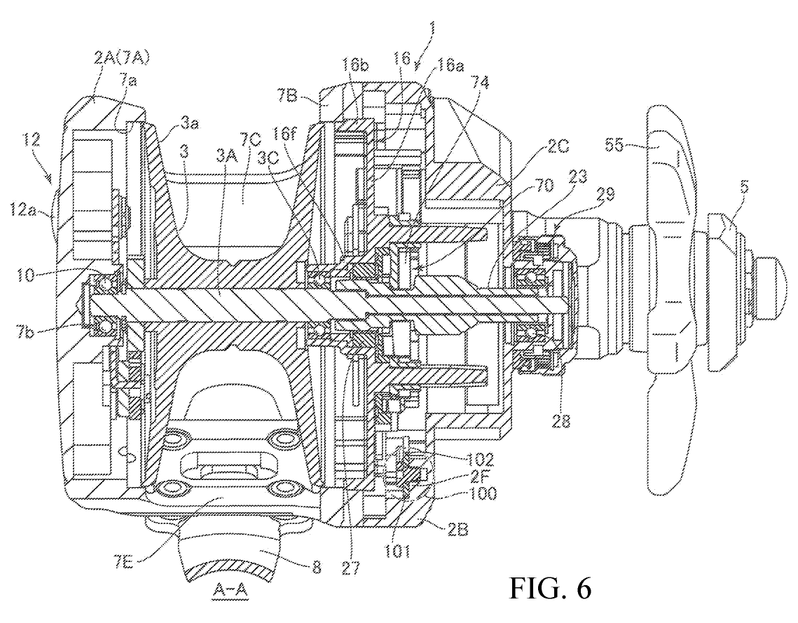

Embodiments of a fishing reel according to the present invention will be described below. FIGS. 1 to 8 are views illustrating a first embodiment (a dual-bearing reel).

A reel body 1 of the dual-bearing reel according to the present embodiment comprises a left-hand side plate 2A and a right-hand side plate 2B, which constitute a housing, and a spool 3 rotatably supported between both the side plates 2A and 2B. In the present embodiment, a handle 5 is provided on a side of the right-hand side plate 2B, and configured to drive and rotate the spool 3 via a known winding-up driving mechanism by a winding-up operation of the handle 5 (a right-hand handle type).

The reel body 1 comprises a frame 7 integrally formed using, for example, an aluminum alloy metal material or the like. The frame 7 comprises a left-hand frame 7A and a right-hand frame 7B which have a roughly circular shape, and both the frames 7A and 7B are coupled to and integrated with a plurality of coupling frames (a front frame 7C in front of the spool 3, a rear frame 7D behind the spool 3, and a lower frame 7E below the spool 3). Note that a reel leg 8 installed at a reel seat (not illustrated) of a fishing rod is integrally disposed on the lower frame 7E along the horizontal direction (the reel leg 8 may be integrated with the frame).

The right-hand side plate 2B is installed on the right-hand frame 7B constituting the frame 7, and a space S in which various functional parts can be housed is disposed between the frame and the side plate. Therefore, the right-hand side plate 2B has a function as a cover body that closes the functional parts (the right-hand side plate is also referred to as the cover body).

Furthermore, the left-hand frame 7A of the present embodiment directly constitutes the left-hand side plate 2A and has, on the inside, an annular recessed portion 7a in which a flange 3a of the spool 3 is housed. Furthermore, the left-hand side plate 2A has a recessed portion 7b disposed in a center region. In the recessed portion 7b, a bearing 10 is arranged to rotatably support a left-hand side end of a driving shaft 3A of the spool 3. Moreover, a known spool stopper 12 is provided in the left-hand side plate 2A to prevent the spool 3 from rotating in a fishing line sending-out direction. The spool stopper 12 comprises a slide lever 12a that protrudes from an outside face of the left-hand side plate 2A. When the slide lever 12a is operated to slide, switching can be performed between a state where the spool 3 is prevented from rotating in the fishing line sending-out direction and a state where the spool 3 is allowed to rotate in the fishing line sending-out direction.

The right-hand frame 7B has a ring shape comprising a circular opening 7d that enables the spool 3 to be detached to a handle side. As described above, the right-hand frame 7B is mounted with the right-hand side plate 2B serving as the cover body, and the right-hand side plate 2B houses various functional parts (components), such as the winding-up driving mechanism, a drag mechanism, or a clutch mechanism, which transmit a rotational driving force of the handle 5 to the spool 3.

The driving shaft 3A is inserted and fixed into a center of the spool 3, and the left-hand side end is rotatably supported on the left-hand side plate 2A (the left-hand frame 7A) by the bearing 10. Furthermore, on a right-hand side of the spool 3 in the driving shaft 3A, a bearing 3C is arranged, and a pin 3D that a pinion gear 23 is engaged with or disengaged from is provided on an outside of an axial direction of the bearing 3C. The pinion gear 23 slides in the axial direction by the clutch mechanism. The diameter of the driving shaft 3A decreases on an outside in the axial direction of a position where the pin 3D is provided, and the driving shaft 3A is inserted into the pinion gear 23.

The right-hand side plate 2B is detachably fixed to the right-hand frame 7B, and the right-hand frame 7B is closed by the right-hand side plate 2B on an opposite side from the spool. Furthermore, the right-hand side plate 2B has a recessed shape in such a way that the space S is generated against the right-hand frame 7B, and the various functional parts described above are arranged in the space S.

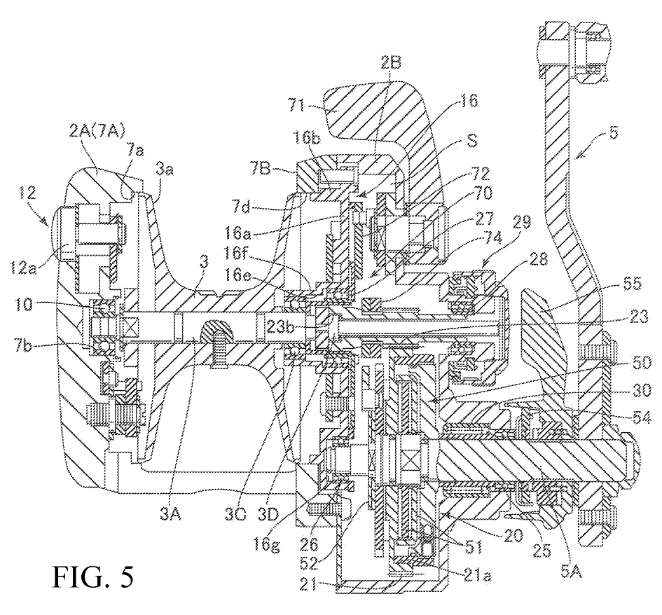

The various functional parts that are arranged in the space S are described below with reference to FIGS. 5 to 8. As described above, in the space S, a winding-up driving mechanism 20, a drag mechanism 50, a clutch mechanism 70, and the like are arranged. The winding-up driving mechanism 20 transmits a rotational driving force of the handle 5 to the spool 3. The drag mechanism 50 applies a desired braking force to a fishing line that is sent out from the spool 3. The clutch mechanism 70 switches the spool 3 between a winding-up state and a free rotation state.

In the present embodiment, a set plate 16 is mounted and fixed to the right-hand side plate 2B, the space S is disposed between the set plate 16 and the right-hand side plate 2B, and the respective mechanisms are arranged in the space S. Stated another way, when the right-hand side plate 2B is removed from the right-hand frame 7B, the winding-up driving mechanism 20, the drag mechanism 50, and the clutch mechanism 70 are located on a side closer to the right-hand side plate 2B than the set plate 16, and components of each of the mechanisms are not exposed (not scattered even if the right-hand side plate 2B is removed from the right-hand frame 7B).

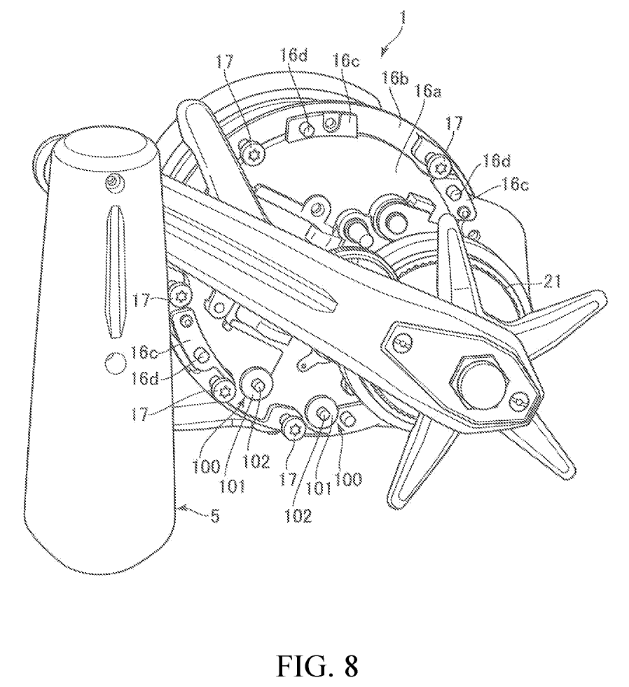

The set plate 16 has a roughly cylindrical shape comprising a support portion 16a having a circular plate shape, and an annular support portion 16b that is disposed at an outer peripheral end of the support portion 16a, and protrudes to a spool side. On an outer peripheral side of the support portion 16a, a plurality of fixing screws 17 are screwed toward the right-hand side plate 2B (see FIG. 8), whereby the set plate 16 is screwed to an inner face side of the right-hand side plate 2B.

In the annular support portion 16b of the set plate 16, fixing parts 16c are disposed at predetermined intervals along the circumferential direction. Each of the fixing parts 16c has a protrusion 16d disposed to be fitted into a fixing hole disposed in the right-hand side plate 2B, and the set plate 16 and the right-hand side plate 2B are positioned by fitting the protrusion 16d into the fitting hole disposed at a corresponding place of the right-hand side plate. In this state, the set plate 16 is screwed to the inner face side of the right-hand side plate 2B.

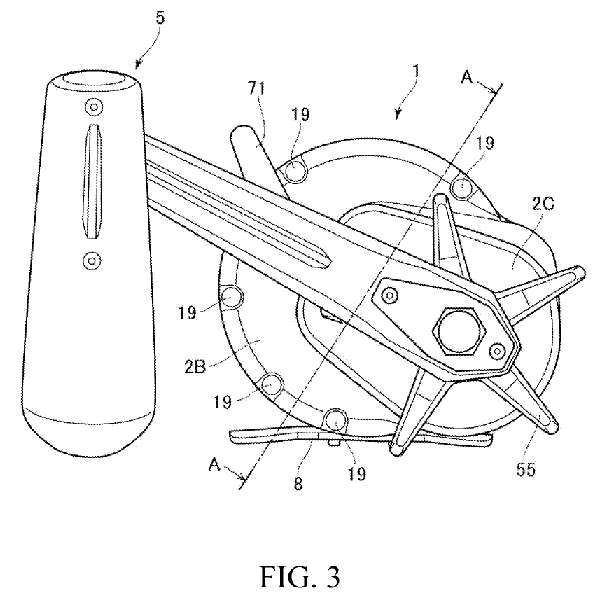

Furthermore, a plurality of fixing screws 19 are screwed into an outer peripheral side of the right-hand side plate 2B, and the right-hand side plate 2B is fixed to the right-hand frame 7B by screwing the respective fixing screws 19 into screw holes disposed at corresponding positions of the right-hand frame 7B (see FIG. 3). Note that the annular support portion 16b of the set plate 16 is fitted to an inner face of the circular opening 7d disposed in the right-hand frame 7B, and the right-hand side plate 2B is fixed to the right-hand frame 7B.

In a center portion of the support portion 16a of the set plate 16, a through-hole 16e is disposed. Around the through-hole 16e, a support portion (an annular wall 16f) is disposed to protrude to the spool side. Furthermore, in a portion on the outer peripheral side of the support portion 16a, a recessed portion 16g is disposed, and is open toward a side of the cover body. In the through-hole 16e, the pinion gear 23 constituting the winding-up driving mechanism 20 is arranged, and in the recessed portion 16g, a proximal end of a handle shaft 5A constituting the winding-up driving mechanism 20 is arranged.

Here, a configuration of the winding-up driving mechanism 20 is described. As described above, in the present embodiment, the handle 5 that drives and rotates the spool 3 is provided on a side of the right-hand side plate 2B, and the winding-up driving mechanism 20 is arranged in the space S between the set plate 16 and the right-hand side plate 2B. The winding-up driving mechanism 20 comprises the handle shaft 5A mounted with the handle 5, a drive gear 21 that is rotatably mounted on the handle shaft 5A, and the pinion gear 23 that is meshed with the drive gear 21.

The handle 5 on which a winding-up operation is performed is mounted on an end of the handle shaft 5A, and the handle shaft is rotatably supported in the right-hand side plate by a bearing 25 and a bearing 26. The bearing 25 is arranged between the handle shaft 5A and the right-hand side plate 2B, and the bearing 26 is arranged between the handle shaft 5A and the recessed portion 16g that is disposed in the set plate 16. The driving shaft 3A of the spool is inserted into the pinion gear 23 that is meshed with the drive gear 21, and the pinion gear 23 is supported to be slidable in the axial direction relative to the driving shaft 3A. In the present embodiment, both sides of the pinion gear 23 are rotatably supported by bearings 27 and 28, respectively. In this case, the bearing 27 is arranged in a portion of the through-hole 16e of the set plate 16, and the bearing 28 is arranged in a known braking device 29 that is mounted on the right-hand side plate 2B, abuts onto an end face of the driving shaft 3A of the spool, and applies a braking force to rotation of the spool.

On the handle shaft 5A, a known one-way clutch 30 is arranged between the handle shaft 5A and the right-hand side plate 2B, and the one-way clutch 30 allows the handle 5 to rotate in the fishing line winding-up direction, and prevents the handle 5 from reversely rotating. Furthermore, on a portion of the handle shaft 5A, the known drag mechanism 50 is arranged, and the drag mechanism 50 applies a desired braking force to the fishing line that is sent out from the spool 3. The drag mechanism 50 comprises a plurality of braking plates 51, a ratchet gear 52, and an operation knob 55. The plurality of braking plates 51 is arranged in an annular recessed portion 21a that is disposed in the drive gear 21. The ratchet gear 52 is whirl-stopped and fixed to the handle shaft 5A to be immoveable in the axial direction, and comes in plane contact with the drive gear 21. The operation knob 55 is disposed on the handle shaft 5A and moves in the axial direction. Therefore, if an operation is performed to rotate the operation knob 55, the braking plates 51 are pressed by a pressing body 54 and an inner ring of the one-way clutch 30, and a desired pressing force acts between the drive gear 21 and the handle shaft 5A. Stated another way, an operation is performed to rotate the operation knob 55, and therefore a pressing force to be applied to the braking plates 51 is adjusted, and a desired drag force can act on the fishing line that is sent out from the spool 3.

Note that a latching claw (not illustrated) can be engaged with the ratchet gear 52. This can reliably prevent the handle shaft 5A from reversely rotating when a reverse rotation avoiding function of the one-way clutch 30 has slipped.

On the set plate 16, the known clutch mechanism 70 is arranged, and the clutch mechanism 70 switches the spool 3 between the winding-up state and the free rotation state. The clutch mechanism 70 comprises an operation member 71, a clutch plate 72, and an engagement member 74. The operation member 71 is arranged on the right-hand side plate 2B, and is supported to be rotationally movable along an outer peripheral face. The clutch plate 72 is supported by the set plate 16 to be rotationally movable, and rotationally moves in accordance with an operation performed on the operation member 71. The engagement member 74 engages with a circumferential groove, which is disposed on an outer peripheral face of the pinion gear 23, and comprises a pair of arms causing the pinion gear 23 to slide in the axial direction by the rotational movement of the clutch plate 72. Stated another way, the clutch plate 72 is driven to rotationally move by operating the operation member 71, and the engagement member 74 is moved in the axial direction against a biasing force of a biasing spring that biases each of the arms by a cam disposed on the surface of the clutch plate. Accordingly, the engagement member 74 causes the pinion gear 23 to slide in the axial direction, an end 23b having a non-circular cross section of the pinion gear 23 is engaged with or disengaged from the pin 3D that is provided in the driving shaft 3A of the spool 3, and switching can be performed between a power transmission state (clutch ON) and a power cutoff state (clutch OFF).

The right-hand side plate 2B comprises a swelling portion 2C that swells in a roughly semicircular shape to partially house the drive gear 21 mounted on the handle shaft 5A. The swelling portion is attached to the right-hand frame 7B by a screw, and is closed by a closing member 61 that is disposed in a roughly semicircular shape. Stated another way, as described above, if the right-hand side plate 2B on which the set plate 16 has been installed is installed on the right-hand frame 7B, the swelling portion 2C is closed by the closing member 61 that has been attached to the right-hand frame 7B as it is.

As described above, a large number of components (functional parts) such as the winding-up driving mechanism, the drag mechanism, and the clutch mechanism are housed in the right-hand side plate of the reel body 1, and these are supported by the set plate 16 as described above. In this case, the large number of components comprise different types of materials that are different in a raw material, and are arranged in a state of being in contact with or in the proximity of each other. Therefore, if conductive liquid such as seawater or water adheres to the large number of components or the large number of components are exposed to such an atmosphere, a flow of electrons is generated due to a potential difference, and this causes corrosion. Furthermore, in the dual-bearing reel as in the present embodiment, the swelling portion 2C is disposed on the right-hand side plate 2B to partially house the drive gear 21 in order to reduce the size.

Therefore, a recessed portion 2D for housing the drive gear is disposed in a region of the swelling portion 2C, thereby forming a structure in which moisture easily accumulates in the recessed portion. Furthermore, in a state where the reel body is mounted to the fishing rod, moisture is received from the upper side, and thus easily accumulates on a lower side of the reel body. Therefore, components (functional parts) arranged in such a region are in an environment where corrosion is likely to occur, and this causes deterioration in rotational performance.

In the present embodiment, an anticorrosion member (corrosion member) 100, which has a potential difference larger than a potential difference between the set plate 16 and the components comprising different types of materials (functional parts such as constituent elements of the winding-up driving mechanism 20 and the clutch mechanism 70 and installation parts such as fixing screws), is screwed to the side plate 2B.

The anticorrosion member 100 comprises a material having a great ionization tendency, such as zinc, titanium, aluminum, or magnesium, and the material is selected and used according to the materials of the components described above. Furthermore, a main body 101 of the anticorrosion member 100 has a washer shape, and the anticorrosion member 100 is screwed to the inner face of the right-hand side plate 2B by screwing a fixing member 102 such as a screw into a hole disposed in a central portion of the main body 101.

The above anticorrosion member 100 made of the material having a great ionization tendency is fixed in contact with the right-hand side plate 2B. Therefore, even if conductive liquid such as seawater or water enters to generate a flow of electrons, the flow of electrons is generated in the anticorrosion member 100 with priority, and corrodes the anticorrosion member 100. This can effectively avoid corrosion of other components.

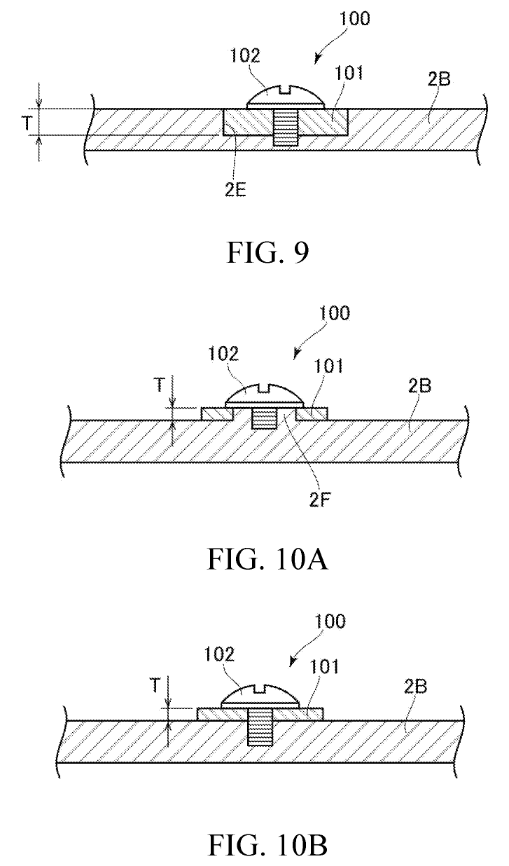

For screwing the anticorrosion member 100, for example, as illustrated in FIG. 9, a roughly circular recessed portion 2E may be disposed in the inner face of the side plate 2B, the main body 101 may be set in the recessed portion 2E, and the anticorrosion member 100 may be fixed with the screw 102 from above. Furthermore, it is preferable to increase a thickness of a portion (region) where the anticorrosion member 100 is screwed so as not to damage the right-hand side plate 2B. Alternatively, as illustrated in FIG. 10A, a projecting portion 2F serving as a seat may be disposed in the side plate 2B at the portion where the anticorrosion member 100 is screwed, thereby improving the fixing strength. Alternatively, as illustrated in FIG. 10B, the main body 101 of the anticorrosion member 100 may have a ring shape, the main body 101 may be set at any position on the side plate 2B, and the screw 102 may be screwed into a hole of the main body 101. In such a configuration, the anticorrosion member 100 can be fixed at an appropriate position.

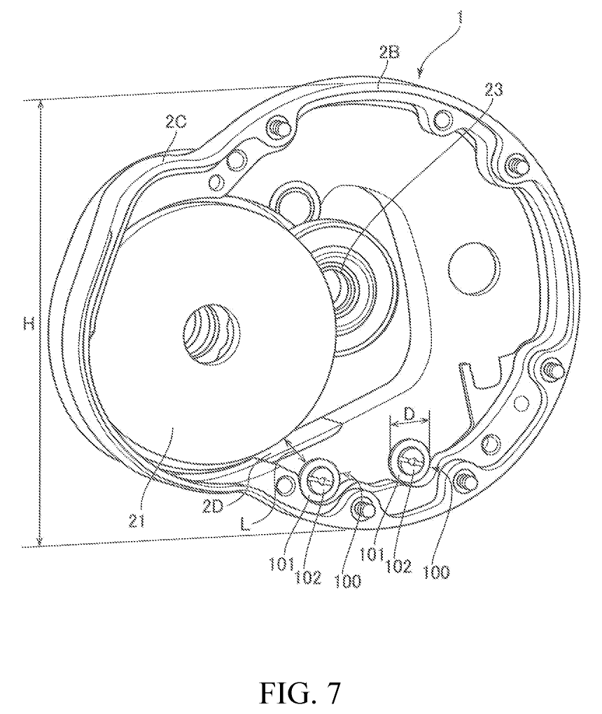

In the present embodiment, the anticorrosion member 100 is installed at two places in the periphery of the pinion gear 23 as illustrated in FIG. 7. The washer-type main body 101 is preferably disposed to have a diameter D of 12 mm or less, preferably 8 mm (product), and a thickness T of about 0.5 to 3 mm, preferably 1 mm. As for an installation position of such a washer, when a distance L between an outer edge of a functional part (in the present embodiment, the outer periphery of the drive gear 21) and an outer edge of the main body 101 is 10 mm or less, preferably about 6 mm, it is possible to make electrons flow to the anticorrosion member 100, and it is possible to exhibit a sufficient anticorrosion effect for the components and smoothly maintain the operation of the winding-up driving mechanism. Note that the above numerical values exemplify a preferable size as the main body 101 and a preferable distance from the components, and the present embodiment is not limited to the above numerical values.

As described above, the sufficient anticorrosion effect for the functional parts can be achieved with the anticorrosion member 100 downsized in a washer type, and thus, it is possible to avoid the reel body from becoming larger than necessary. Furthermore, the anticorrosion member 100 may be fixed to the right-hand side plate 2B, or may have a structure that is detachably attached so as to be replaceable.

According to the configuration of the anticorrosion member 100 of the present embodiment, even if the recessed portion 2D is disposed in the right-hand side plate 2B, the anticorrosion member 100 can be installed at such a position. Stated another way, even in a portion or a shape where moisture is likely to be accumulated, the flow of electrons is generated in the anticorrosion member 100 with priority due to a large potential difference so that it is possible to effectively avoid corrosion of the drive gear 21 and the pinion gear 23.

Furthermore, according to the washer-type anticorrosion member 100 described above, when a height (maximum height) of the right-hand side plate 2B with respect to the horizontal direction in a state where the reel body 1 is mounted to the fishing rod is defined as H (see FIG. 7), the anticorrosion member 100 can be screwed within a range of 1/2H or less of the right-hand side plate.

As described above, although the lower side of the reel body 1 is a region where moisture is likely to be accumulated, the washer-type anticorrosion member 100 can be easily arranged in this region, so that the corrosion of the functional parts can be effectively suppressed.

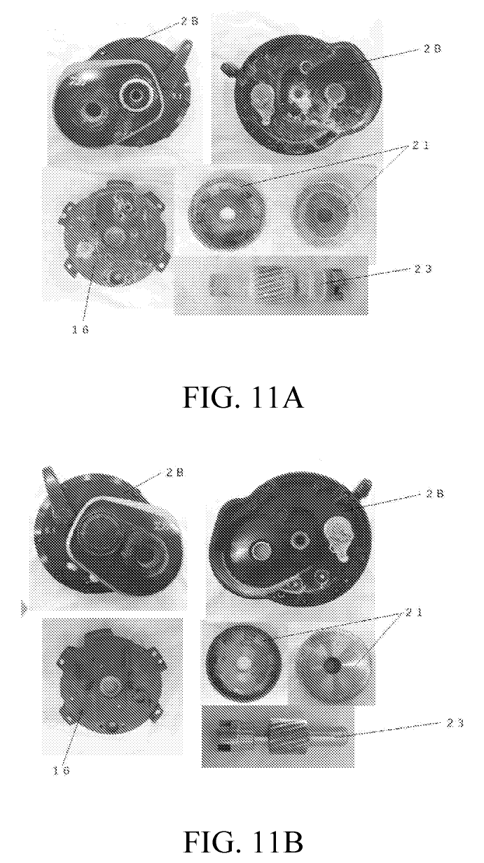

Here, an experimental result of a change state of the components when the fishing reel with the above washer-type anticorrosion member 100 mounted in the periphery of the drive gear and the pinion gear of the right-hand side plate 2B is continuously immersed in seawater will be described with reference to photographs of FIGS. 11A and 11B.

FIGS. 11A and 11B are photographs showing corrosion states when a corrosion experiment was performed using the dual-bearing reel illustrated in FIGS. 1 to 10B. FIG. 11A is an example in which the above washer-type anticorrosion member is not mounted, and FIG. 11B is an example in which the above washer-type anticorrosion member is mounted. In the experiment, the dual-bearing reel in which the washer-type anticorrosion member was not mounted to the right-hand side plate 2B and the dual-bearing reel in which the washer-type anticorrosion member was mounted to the right-hand side plate 2B were repeatedly immersed in seawater and dried a plurality of times, and resultant states thereof were photographed.

As in the photograph of FIG. 11A, when the washer-type anticorrosion member was not mounted, white irregular precipitates appeared and corrosion occurred in a region where the components were provided on an inner face and a part of an outer face of a main portion of the right-hand side plate 2B. Furthermore, such precipitates were observed not only on the right-hand side plate 2B but also in surface regions of the set plate 16, the drive gear 21, and the pinion gear 23.

On the other hand, as in the photograph of FIG. 11B, when the washer-type anticorrosion member was mounted to the right-hand side plate, no precipitate appeared on the inner and outer faces of the right-hand side plate 2B, and the surface regions of the set plate 16, the drive gear 21, and the pinion gear 23. However, precipitates appeared around the washer-type anticorrosion member.

As described above, when the washer-type anticorrosion member is screwed to a peripheral region where the components are arranged on the right-hand side plate, the potential difference between the anticorrosion member and the functional parts increases to generate the flow of electrons, so that the anticorrosion member 100 can be proactively corroded, and the corrosion of other components can be avoided. In this case, the anticorrosion member is simply configured to be screwed to the inner face of the right-hand side plate (in a small washer shape), and thus can be easily installed in the peripheral region of the components, particularly, in a portion where moisture is likely to be accumulated (the recessed portion of the side plate or the set plate, the lower side of the reel body, a portion where various components are concentrated), whereby the corrosion of the components can be effectively suppressed.

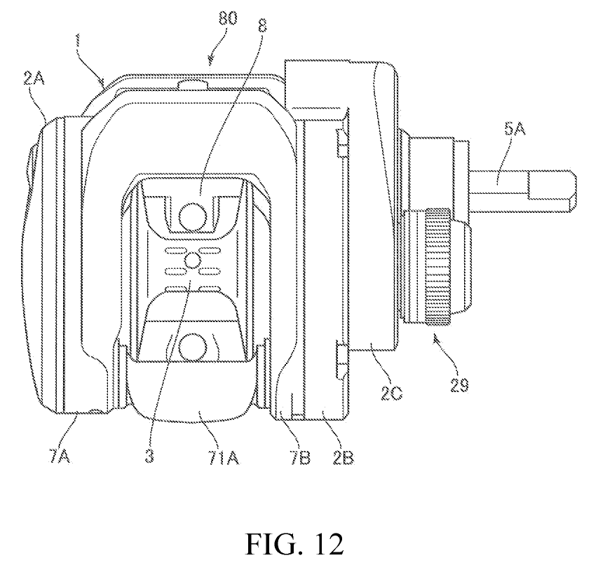

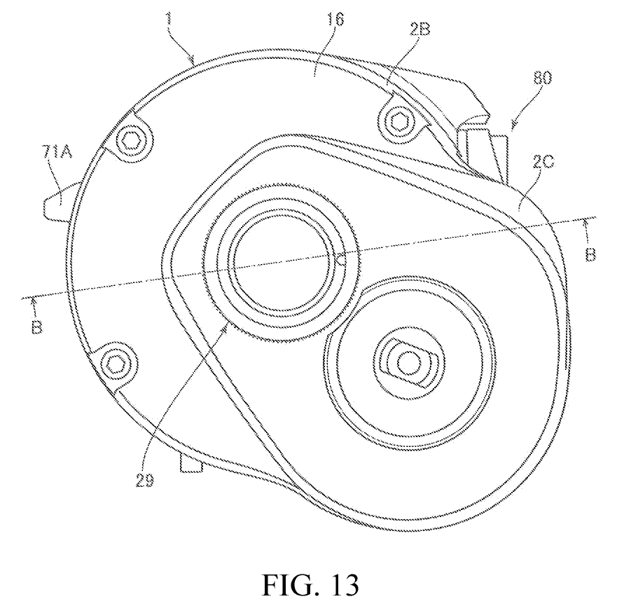

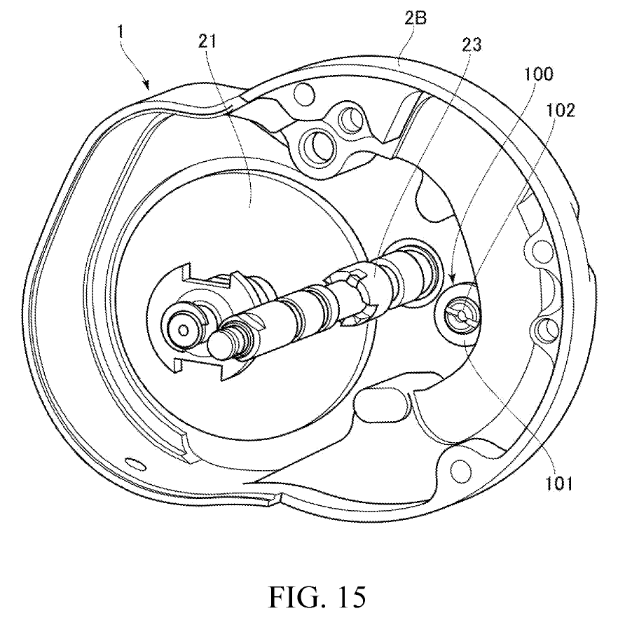

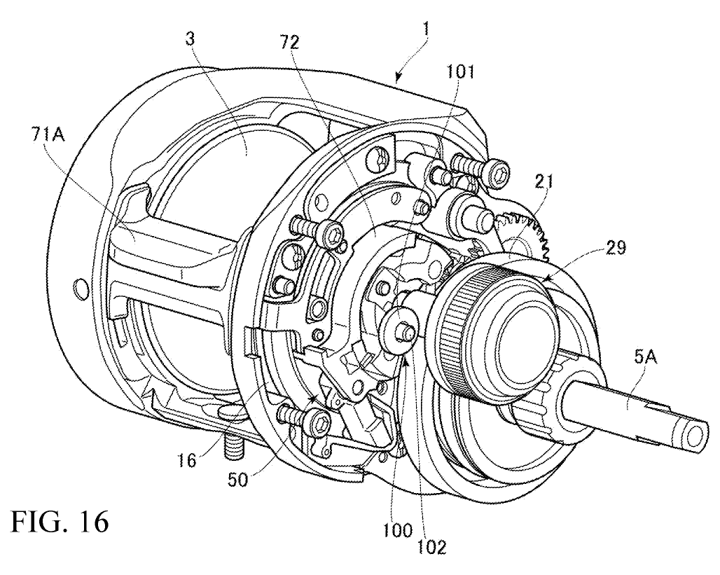

FIGS. 12 to 16 are views illustrating a second embodiment of the fishing reel. This embodiment is a general dual-bearing reel such as a bait casting reel, and illustrates an example in which a washer-type anticorrosion member is arranged on an inner face of a side plate constituting a reel body. Hereinafter, in the description of the present embodiment, configurations having functions similar to those of the above embodiment are denoted by the same reference numerals, and detailed description thereof will be omitted.

In the reel body 1 of the dual-bearing reel of the present embodiment, a known level wind mechanism 80 is arranged on a front side of the spool 3 rotatably supported between the left-hand side plate 2A and the right-hand side plate 2B, and an operation member 71A of the clutch mechanism 70 is arranged on a rear side of the spool 3 so as to be vertically movable. Also in the present embodiment, a handle (not illustrated) is provided on a side of the right-hand side plate 2B, and configured to drive and rotate the spool 3 via a winding-up driving mechanism by a winding-up operation of the handle (a right-hand handle type).

In the dual-bearing reel described above, when the clutch mechanism 70 is brought into a power non-transmission state (clutch OFF), the operation member 71A is pressed downward. The clutch mechanism 70 comprises the clutch plate 72 and the engagement member 74. The clutch plate 72 is supported by the set plate 16 to be rotationally movable, and rotationally moves in accordance with the pressing operation of the operation member 71A. The engagement member 74 engages with a circumferential groove, which is disposed on an outer peripheral face of the pinion gear 23, and comprises a pair of arms causing the pinion gear 23 to slide in the axial direction when an operation is performed to rotationally move the clutch plate 72.

Stated another way, the clutch plate 72 is driven to rotationally move by pushing down the operation member 71A, and the engagement member 74 is moved in the axial direction against a biasing force of a biasing spring that biases each of the arms by a cam disposed on the surface of the clutch plate. Accordingly, the engagement member 74 causes the pinion gear 23 to slide in the axial direction, an end having a non-circular cross section of the pinion gear 23 is engaged with or disengaged from a pin that is provided in the driving shaft 3A of the spool 3, and switching can be performed between a power transmission state (clutch ON) and a power cutoff state (clutch OFF).

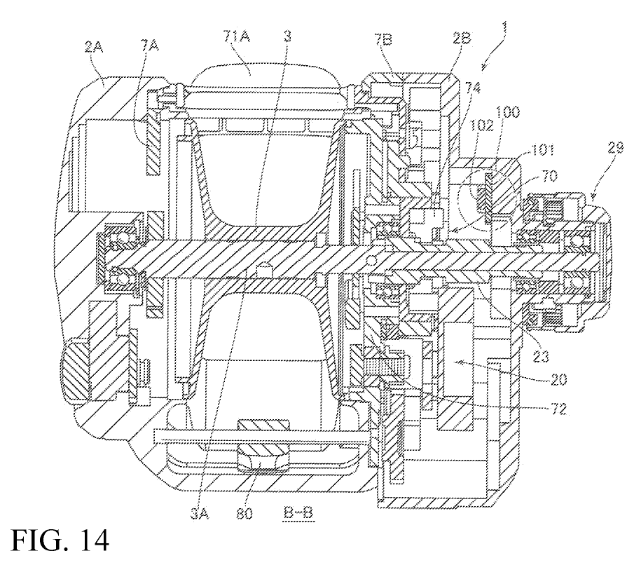

Since a large number of functional parts are concentrated in the clutch mechanism 70, it is preferable to screw the anticorrosion member 100 to the right-hand side plate 2B in a peripheral region of the clutch mechanism (see FIGS. 14 to 16). In this case, in the present embodiment, the clutch mechanism 70 is provided on the right-hand side plate at a side portion of the pinion gear 23 that slides in the axial direction.

As described above, as for the clutch mechanism 70, components such as the clutch plate 72 that rotationally move in accordance with the pressing operation of the operation member 71A, the pinion gear 23, and the engagement member 74 comprising the pair of arms engaging with the circumferential groove disposed on the outer peripheral face of the pinion gear 23 and causing the pinion gear 23 to slide in the axial direction when the operation is performed to rotationally move the clutch plate 72, are densely disposed. Therefore, the washer-type anticorrosion member 100 is arranged in a peripheral portion of the clutch mechanism at the above-described position, so that it is possible to effectively avoid corrosion of a portion of the clutch mechanism in which moisture is likely to be accumulated and to perform a stable clutch operation.

Note that the number and positions of the anticorrosion members 100 to be installed can be modified as appropriate. In this case, the anticorrosion member 100 is preferably screwed in the vicinity of at least a part of at least one component (one gear in the case of meshing gears) among components of the winding-up driving mechanism 20 and the clutch mechanism 70, the components being in contact with each other. Specifically, as for the “vicinity”, an arrangement mode in which the component and the screwed anticorrosion member overlap each other when viewed from above (in the case of a drive gear, an arrangement mode in which the anticorrosion member 100 and the drive gear 21 overlap each other even in the state of being separated from each other in the axial direction) is preferable, and a configuration in which the component and the anticorrosion member are not in contact with each other may be adopted.

Since the washer-type anticorrosion member 100 is arranged in the periphery of the winding-up driving mechanism and a gear that transmits power (for example, a power transmission gear portion of the level wind mechanism 80), corrosion of components thereof can be effectively suppressed, so that it is possible to suppress corrosion of a driving portion by installing the washer-type anticorrosion member at an optimal position regardless of an installation position.

According to the present invention, as described above in the embodiments, a corrosion member can be attached or detached inside a reel body of a fishing reel or on a surface (a position that fails to be visually recognized is preferable) of a component member that is exposed to an outside of the reel body. In a case where corrosion has been worsened, a maintenance task can be performed to replace the corrosion member with a dedicated corrosion member. Therefore, the present invention comprises a corrosion member that can be attached to or detached from a portion where component members comprising different types of materials are arranged in a contact state or a proximity state, and that comprises a material having a potential difference that is greater than a potential difference between the component members comprising the different types of materials. Such a corrosion member can be manufactured and sold as a replacement part (a dedicated product), and a shape may be specified depending on an installation position or an installation method, a block shape may be employed rather than a plate shape, or a shape that achieves some functions may be employed.

Furthermore, such a corrosion member is formed in a zinc plate shape, and this enables a satisfactory processibility and a reduction in a cost.

The embodiments of the present invention have been described above, but the present invention is not limited to the above-described embodiments and may be modified in various ways.

As the fishing reel, various reels such as a spinning reel, an electric reel, and a single-bearing reel can be applied, in addition to the above dual-bearing reel. In this case, a washer-type anticorrosion member may be installed in a housing portion that constitutes a reel body and houses various components. Such a mounting position can also be variously changed. Furthermore, corrosion does not only occur in contact between metal members, but also occurs, for example, in the case of different types of materials such as carbon and aluminum. Therefore, an anticorrosion member 100 comprising an optimal material may be mounted in consideration of a potential difference generated between components. In the above configuration, a washer shape may be an elliptical shape or a polygonal shape other than a disk shape (ring shape). A main body of the anticorrosion member can have various shapes. For example, the anticorrosion member may be formed in a plate shape that is thin and small (the maximum length is 12 mm or less) and be fixed in a side plate, and can be appropriately modified in accordance with its arrangement position. Moreover, a method of fixing the anticorrosion member to the side plate or the housing may be adhesion or the like.

Moreover, the configuration requirements described in the claims may be implemented in any combination.

What is claimed is:

1. A fishing reel comprising:
a reel body comprising a spool around which a fishing line is wound, a handle configured to perform a winding-up operation on the spool, a winding-up driving mechanism installed between the spool and the handle and configured to transmit the winding-up operation of the handle to the spool,
wherein the reel body further comprises a side plate that covers the winding-up driving mechanism, and
a washer-type anticorrosion member is screwed to the side plate.

2. The fishing reel according to claim 1, wherein
the winding-up driving mechanism comprises a drive gear and a pinion gear that are driven to rotate by the winding-up operation of the handle, and
the anticorrosion member is provided in a periphery of the drive gear and/or the pinion gear.

3. The fishing reel according to claim 1, wherein
the winding-up driving mechanism comprises a pinion gear that is installed on a rotation shaft of the spool and meshes with the drive gear,
the pinion gear is engaged with a clutch mechanism that turns on and off power transmission with respect to the spool performed by the winding-up driving mechanism, and
the anticorrosion member is provided in a periphery of the clutch mechanism.

4. The fishing reel according to claim 1, wherein a portion of the side plate to which the anticorrosion member is screwed is increased in thickness.

5. The fishing reel according to claim 1, wherein the side plate has a projecting portion disposed at a portion where the anticorrosion member is screwed.

6. The fishing reel according to claim 1, wherein, when a height of the side plate with respect to a horizontal direction in a state where the reel body is mounted to a fishing rod is defined as H, the anticorrosion member is screwed within a range of 1/2H or less of the side plate.

7. The fishing reel according to claim 1, wherein the anticorrosion member is screwed in a vicinity of at least a part of at least one of components of the winding-up driving mechanism, the components being in contact with each other.

8. A fishing reel comprising:
a reel body comprising a spool around which a fishing line is wound, a handle configured to perform a winding-up operation on the spool, a winding-up driving mechanism installed between the spool and the handle and configured to transmit the winding-up operation of the handle to the spool,
wherein the reel body further comprises a housing that houses the winding-up driving mechanism, and
a washer-type anticorrosion member is screwed to an inner face of the housing.

9. The fishing reel according to claim 8, wherein
in the housing, component members comprising different types of materials, which are different in a raw material, are arranged, and
the anticorrosion member comprises a material having a potential difference that is greater than a potential difference between the component members comprising the different types of materials in a periphery of the constituent members.

10. The fishing reel according to claim 1, wherein the washer-type anticorrosion member has a ring shape having a thickness of 0.5 to 3 mm and a diameter of 12 mm or less.

11. The fishing reel according to claim 10, wherein the washer-type anticorrosion member is fixed to the side plate by screwing a screw into a hole of a ring-shaped main body.

12. A fishing reel comprising:
a reel body comprising a spool around which a fishing line is wound, a handle configured to perform a winding-up operation on the spool, a winding-up driving mechanism installed between the spool and the handle and configured to transmit the winding-up operation of the handle to the spool,
wherein the reel body further comprises a housing that houses the winding-up driving mechanism, and
an anticorrosion member having a maximum length of 12 mm or less is fixed to an inner face of the housing.
